(19) United States
(12) Patent Application Publication
(10) Pub. No.: US 2009/0233253 A1
(43) Pub. Date: Sep. 17, 2009

(54) Dental shade guide

(76) Inventor: William R. Mrazek, Naperville, IL (US)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 12/341,534

(22) Filed: Dec. 22, 2008

Related U.S. Application Data
(60) Provisional application No. 61/015,899, filed on Dec. 21, 2007.

(51) Int. Cl. A61C 19/10

(52) U.S. Cl. 433/26

(57) ABSTRACT

A new color shade guide for use in dentistry has two linearly-arranged sets of shade guides. One set includes only conventional ‘M’ hues, the other set includes only conventional ‘L’ and ‘R’ hues. Each of the two sets is arranged with the guides in a single line. Fasteners are attached to one of the sets of shade guides and enables the two sets to be connected together, back-to-back, enabling a practitioner to view all of the tooth shades in the system by simply rotating the attached guides. Blue and violet colored translucent sheets are included in a kit to enable a practitioner to efficiently isolate the ‘value’ component of the Munsell color system by comparing the perceived color of the tooth or teeth as viewed through the colored sheet with the perceived color of the shade guide as viewed through the same sheet.

### CROSS-REFERENCE TO RELATED APPLICATIONS

This application claims the benefit of U.S. provisional application Ser. No. 60/015,889, filed Dec. 21, 2008.

### BACKGROUND OF THE INVENTION

The present invention relates generally to color shade guides used in dentistry. The new and improved shade guide system offers a more efficient and practical approach to the shade matching procedure over the original VITA 3D-MASTER shade guide.

In dentistry, the Munsell color system can be used for specifying the color of teeth. Broadly, the Munsell system specifies color based on three color dimensions: hue, value (lightness), and chroma (color purity or colorfulness). Hue corresponds with the name given to the colors at a particular wedge of a color wheel. The hue of teeth is generally characterized as red (“R”), yellow (“L”), or an intermediate hue (“M”). Value, or lightness, can theoretically vary from black to white. Chroma represents the “purity” of a color, with lower chroma being less pure (more washed out, as in pastels).

Description of Existing VITA 3-D MASTER Design and Features

The existing VITA 3D-Master shade guide consists of 26 shades, which are designated into linear groups numbered 1 through 5 denoting different value levels, with level 1 being higher in value (closer to white), and the groups being progressively lower in value as the group number increases toward 5 (closer to black). In groups 2, 3, & 4, the shade tabs are linearly arranged by hue. “L” group tabs, on the left side of each value grouping, are more prominent in the yellow range of color. “R” group tabs, arranged on the right side of each value grouping, are more prominent in the red range of color. “M” group tabs, arranged in thee middle of each value grouping, are in-between in hue with a balance of yellow and red. All tabs in each value group are also arranged vertically, one behind the other, with designations of 1, 2, & 3 for those tabs in the M group, and 1.5 & 2.5 for the tabs in the L & R groups and the tabs in value 1. These numbers designate increase in chroma levels (more color purity) as the number designation increases.

In addition to the 26 shade tabs mentioned above, VITA has introduced bleach shades, OM-1, OM-2, and OM-3. These 3 tabs are attached to the left side of the VITA 3D-MASTER shade guide with a modified holder that is supplied with the bleached shade tabs.

It has been documented by VITA that 75-80% of those shades that occur in human dentition can be found in the M category of the 3D-Master system. It is estimated that another 5-10% of the population match the 3 bleached shades.

After 10 years of being marketed, VITA has found that use of the 3D-Master system shade guide has been limited, with a preference by practitioners to use the 16 tab VITA CLASSICAL shade guide. It is apparent that many practitioners are more comfortable with the simplified linear design of the CLASSICAL guide, and many have difficulty distinguishing the value of teeth when comparing the color of natural teeth to the shade guide.

All of the new dental porcelain and denture tooth products manufactured by VITA are designed around the 3D-MASTER shade system. Because of the limited acceptance by practitioners of the 3D-MASTER guide, and because practitioners sometimes are not specifying those shades to the dental laboratory for the fabrication of dental restorations, the sale of the new 3-D MASTER based VITA products has been limited. Also, since VITA has chosen not to manufacture their new dental products in the VITA CLASSICAL shades, they are losing significant market share to competing manufacturers that do offer the same type of products in colors that are identified using the VITA CLASSICAL system.

### BRIEF SUMMARY

The new shade guide follows the 3D-MASTER philosophy of individual matching of value, chroma, and hue. It also is designed in a linear fashion, which is consistent with the VITA CLASSICAL shade guide that practitioners have been using almost exclusively for generations. The use of a linear arrangement may result in greater acceptance and use of the guide in the dental practice by providing a shade matching method that remains in an established comfort zone of use.

The new, alternative design described here consists of two linearly-arranged shade guide components. The first main component is referred to here as a “3D-Direct-M”, and the second is referred to as a “3D-Direct-LR”. Two new and unique features for this design are:

1. The ability to connect the two components together, back-to-back, through the use of magnets or comparable fasteners attached to each component, allowing the practitioner to view all of the tooth shades in the system by simply rotating the attached components.

2. The inclusion of business card-sized blue and violet translucent plastic sheets that can be used by the practitioner to efficiently isolate the ‘value’ component of the Munsell color system.

### BRIEF DESCRIPTION OF THE DRAWINGS

The invention may be better understood by referring to the accompanying drawings, in which:

FIG. 1 is a front view of one part of the new system.

FIG. 2 is a front view of another part of the new system.

FIG. 3 is a view of translucent sheets that can be used with the system.

FIG. 4 is a view of the translucent sheets seen in FIG. 3 being held in front of the guide seen in FIG. 2.

FIG. 5 is a view of one of the translucent sheets seen in FIG. 3 being held in front of the guide seen in 1.

FIG. 6 is a back view of the guides seen in FIGS. 1 and 2.

FIG. 7 is a view of the two guides attached together, with the guide of FIG. 1 facing forward.

FIG. 8 is another view of the two guides attached together, this one with the guide of FIG. 2 facing forward.

FIG. 9 is a side view of the two guides attached together.

FIG. 10 is a front view of the guides and sheets being held in a stand.

### DETAILED DESCRIPTION

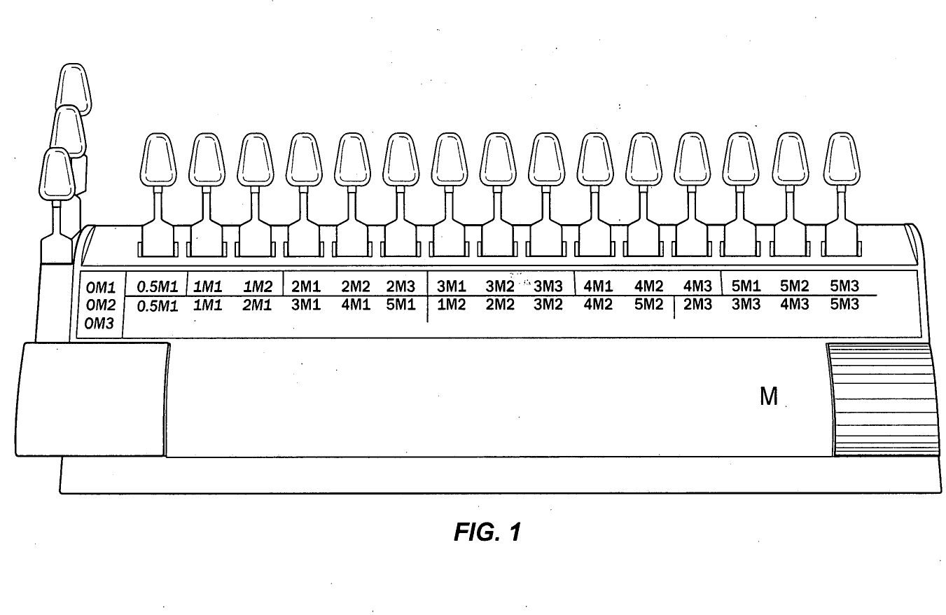

The new system arranges all of the shade tabs in a linear-only fashion. The first main component of the new system is the 3D-Direct-M shade guide seen in FIG. 1. This shadeguide is structurally similar to the recently introduced VITA Bleachedguide 3D-MASTER, and has all of the ‘M’ shades, as well as the 3 bleached shades, and the 0.5 M1 shade tab that is included in the VITA Bleachedguide MASTER. For improved accuracy, and because most teeth fall in the M hue classification, this guide does not include shade tabs in the L and R hues. The guide also has a white insert on the left-hand side and a grey insert on the right-hand side, designating the decrease in ‘value’ in the shade tabs from the left side to the right side. This component enables the practitioner to use the same approach to shade-taking as with the CLASSICAL guide.

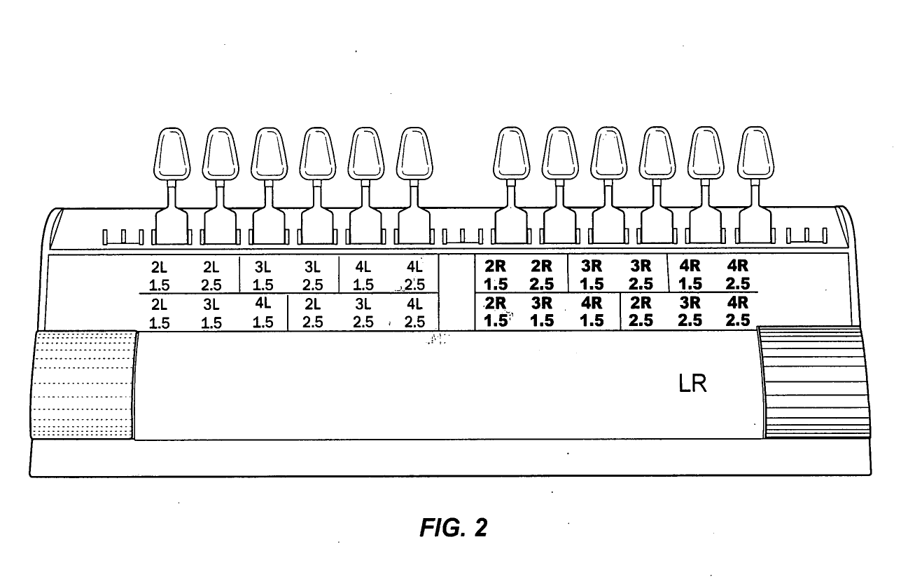

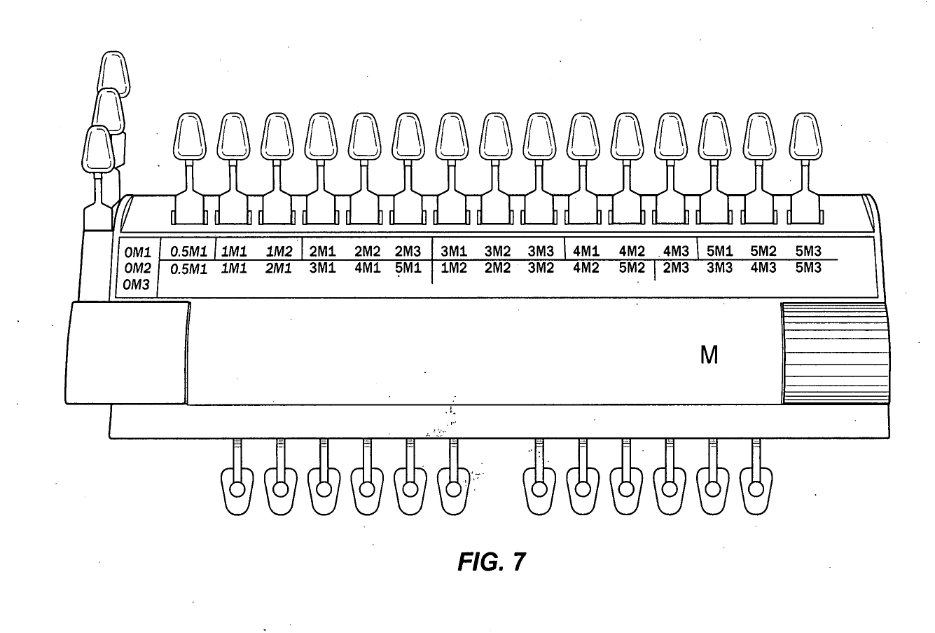

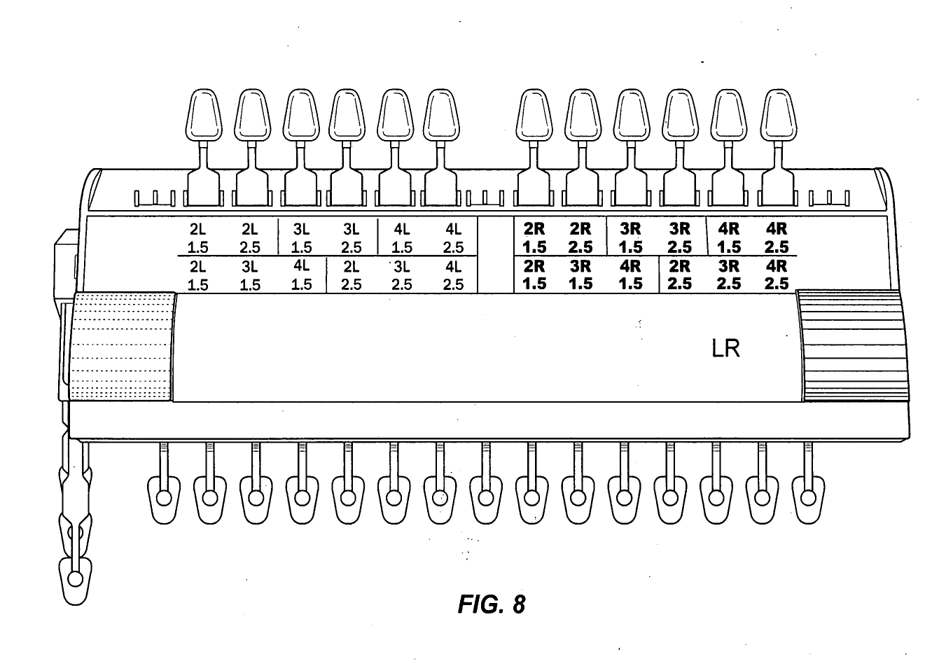

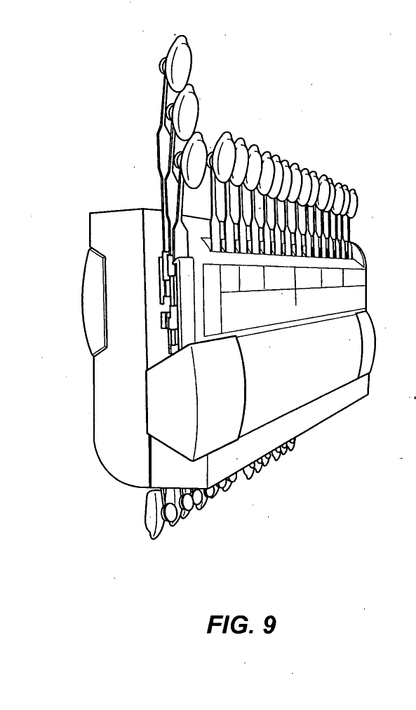

In the event that the actual tooth shade may exhibit more yellow or orange that what is found in any of the tabs of the ‘M’ guide, the practitioner can attach the 3D-DIRECT-LR guide (seen in FIG. 2) to the back of the ‘M’ guide using fasteners such as magnets (seen in FIG. 6) to hold the guides together. In the attached arrangement, seen in FIGS. 7-9, the tabs of each guide are rotated 180 degrees from each other. If there is no good match on the ‘M’ guide, the practitioner can flip the combined components over to position the ‘LR’ guide in front of the patient's teeth and then use the tabs on that guide to determine whether the natural tooth color matches any of the ‘L’ or ‘R’ shade tabs. The illustrated ‘LR’ guide has a yellow insert on the left-hand side and a red insert on the right-hand side to visually designate the ‘L’ and ‘R’ hue groups.

The practitioner can verify his/her selection by rotating the attached shade guides to view the ‘M’ & ‘Bleached’ tabs and then the ‘L’ & ‘R’ tabs. It should be possible to complete the entire shade taking process in 3 minutes or less.

Description of 3D-MASTER DIRECT VALUE DETERMINATION System

The determination of ‘value’ in dental shades is best understood with a description of the simple color wheel. Three primary colors exist naturally in nature: red, yellow, and blue. If any two primary colors are mixed in equal amounts, secondary colors are produced. Red and yellow create orange, yellow and blue create green, and red and blue create violet. In the color wheel, a primary color and the secondary color that is directly opposite it have a complementary relationship, and are called complements of each other. The complement of blue is orange, the complement of yellow is violet, and the complement of red is green. When two direct complements are mixed together in equal amounts, grey is produced. In effect, the addition of the complement over its designated primary color de-saturates the chroma of the primary color.

As stated earlier, it is difficult for many practitioners to discriminate and separate ‘value’ from ‘chroma’. Since ‘value’ is thought to be the most important component of accurately matching dental shades, it is desirable to provide a simple procedure for isolating value from the other color related components.

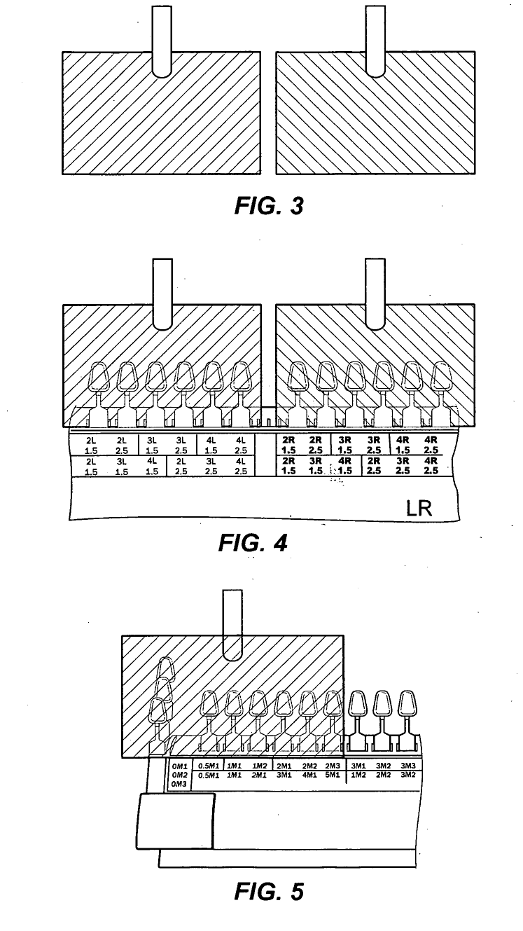

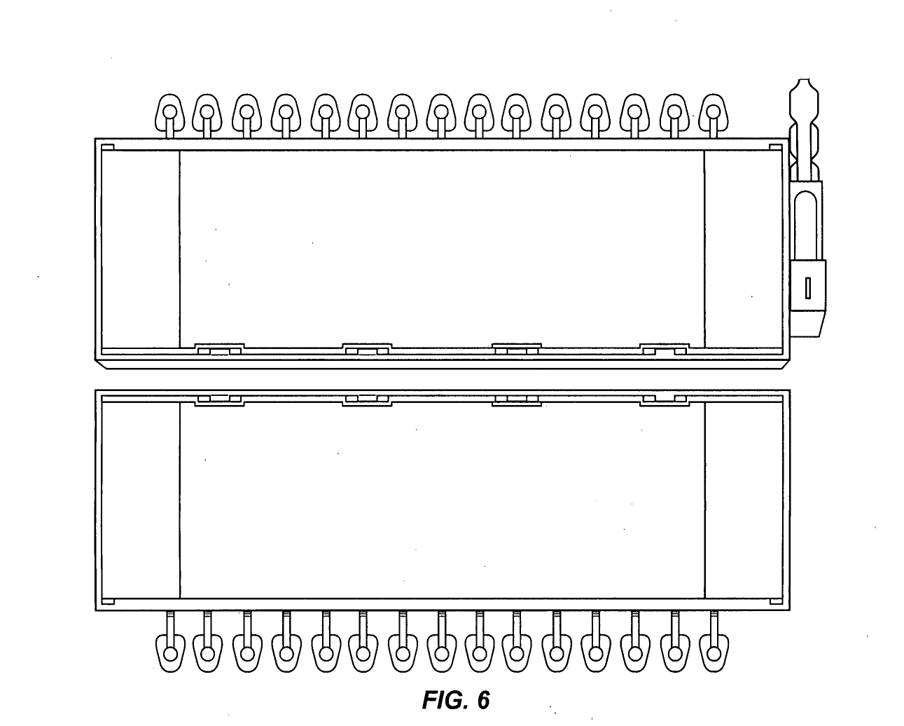

Translucent violet and blue plastic sheets, such as those seen in FIG. 3, can be used for this purpose. Since all of the shade tabs are divided into value groups (0 through 5), the practitioner can simply hold either the blue or violet translucent plastic sheet in front of the 3D-MASTER-M guide, covering, for example, the bleached, 0.5M1, and the 1M1 through 5M1 shade tabs (as seen in FIG. 5). When also held in front of the patient's teeth, the complementary-colored translucent plastic sheet de-saturates the chroma of the tabs and natural teeth, allowing the practitioner to simply and accurately find the correct ‘value’ match of the natural teeth. Once the ‘value’ level is determined (0 through 5), the practitioner can then compare that level tab in either the M, L, or R series and makes the final selection based upon hue and chroma levels.

If the practitioner selects an M shade and wants to verify the value level again, either the blue or violet sheet can be held in front of the tab and the tooth. If a Y shade is selected, then preferably the violet plastic sheet would be used. If an R shade is chosen, the blue plastic sheet would preferably be used, as seen in FIG. 4.* Each plastic sheet can be patient specific for infection control reasons, and discarded after a single use.

Even though the true complement to red is green, blue can be used in the shade-taking process because the saturation level of red in natural teeth is very subtle, thereby creating more of an orange appearance than a red appearance.

Even with this extra step of using the translucent sheets, it should take no more than 3 minutes to accomplish an accurate shade match.

Designations for Two Possible Shade Tab Arrangements

The disclosed 3D-MASTER DIRECT shade guide system also allows the practitioner to arrange the shade tabs in two different sequence orders. This accommodates practitioners who prefer to have their shade guides arranged in order of increasing chroma, rather than arranged in value groups. As seen in FIG. 1, the sequence for each order is printed below each individual tab on the holder.

1. The top line sequence groups the shades by value groups (0-5), with the shades in each value group listed in increasing chroma level order.

2. The second, alternative sequence lists the shades in chroma level groups, with the shades in each chroma group listed in decreasing value order.

Shade Guide Stand

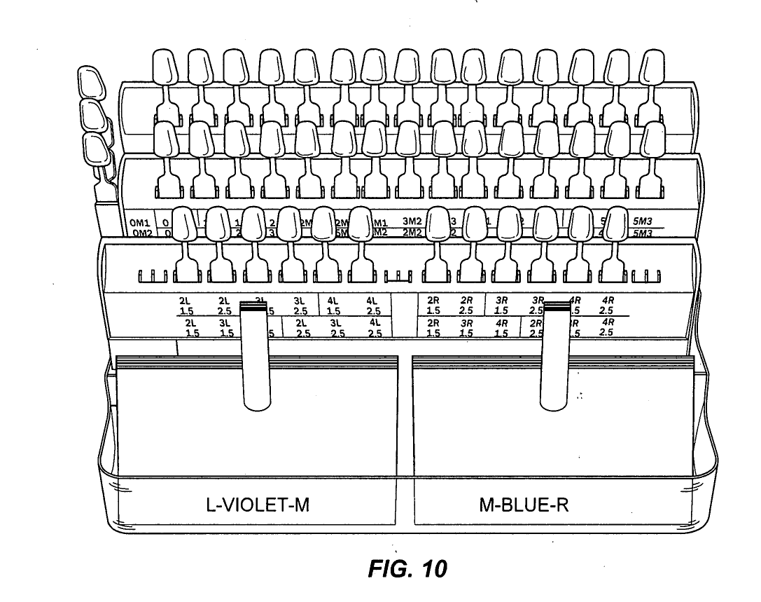

As seen in FIG. 10, the entire 3D-DIRECT shade system, including the translucent value sheets, and the existing VITA Bleachedguide 3D-MASTER can be contained in the modified business card holder for table top display, convenience, and easy access.

This description of various embodiments of the invention has been provided for illustrative purposes. Revisions or modifications may be apparent to those of ordinary skill in the art without departing from the invention.

1. A dental shade guide kit that includes:
a first set of shade guides arranged in a single line;
a second set of shade guides arranged in another single line; and
fasteners that are attached to one of the sets of shade guides and enable the two sets to be connected together, back-to-back, enabling a practitioner to view all of the tooth shades in the system by simply rotating the attached components.

2. The shade guide kit of claim 1, in which the fasteners are magnets.

3. The shade guide kit of claim 1, in which the kit also includes:
colored translucent sheets that can be used by the practitioner to efficiently isolate the ‘value’ component of the Munsell color system.

4. The shade guide kit of claim 1, in which the kit also includes:
blue- and violet-colored translucent sheets.

5. The shade guide kit of claim 1, in which the first set of shade guides includes only conventional ‘M’ hues, and not ‘L’ or ‘R’ hues.

6. The shade guide kit of claim 1, in which the first set of shades includes only conventional ‘M’ hues, and not ‘L’ or ‘R’ hues, and has a white insert at one lateral end and a gray insert on an opposite lateral end.

7. A shade guide kit as recited in claim 1, in which the second set of shade guides includes only conventional ‘L’ and ‘R’ hues.

8. A shade guide as recited in claim 1, in which the second set of shade guides includes conventional ‘L’ hues on one lateral side, and conventional ‘R’ hues on the other lateral side.

9. A method of identifying the shade of one or more teeth by using the steps of:
holding a shade guide next to the tooth or teeth;
covering the shade guide and the tooth with a blue- or violet-colored translucent sheet; and
comparing the perceived color of the tooth or teeth as viewed through the colored sheet with the perceived color of the shade guide as viewed through the colored sheet.
